(19) United States
(12) Patent Application Publication
(10) Pub. No.: US 2020/0280725 A1
(43) Pub. Date: Sep. 3, 2020

(54) VIDEO DATA ENCODING

(71) Applicant: SZ DJI TECHNOLOGY CO., LTD., Shenzhen (CN)

(72) Inventor: Lei ZHU, Shenzhen (CN)

(21) Appl. No.: 16/877,027

(22) Filed: May 18, 2020

Related U.S. Application Data
(63) Continuation of application No. PCT/CN2018/074567, filed on Jan. 30, 2018.

(51) Int. Cl. H04N 19/159; H04N 19/124; H04N 19/91; H04N 19/61; H04N 19/30; H04N 19/176

(52) U.S. Cl. CPC H04N 19/159; H04N 19/124; H04N 19/176; H04N 19/61; H04N 19/30; H04N 19/91

(57) ABSTRACT

A method of encoding video data includes inter-coding a block of an image frame to generate an inter-coded block, reconstructing the inter-coded block to generate a reconstructed block, and intra-coding the reconstructed block to generate a double-coded block.

### CROSS-REFERENCE TO RELATED APPLICATION

This application is a continuation of International Application No. PCT/CN2018/074567, filed Jan. 30, 2018, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to information technology and, more particularly, to a method and apparatus of encoding video data.

### BACKGROUND

Periodic intra-coding or periodic intra-refresh has been widely applied in the field of robust video transmission over unreliable channels. Inter-frame flicker (simply, flicker) refers to a noticeable discontinuity between an intra-frame (intra-coded frame) and a preceding inter-frame (inter-coded frame), and is more perceptibly apparent at periodic intra-frames in low-to-medium bit-rate coding, which is commonly used in bandwidth-limited and latency-sensitive applications, such as wireless video transmission applications. The flicker is mainly attributed to large differences in coding noise patterns between inter-coding and intra-coding. That is, the fact that the decoded intra-frame does not resemble the preceding decoded inter-frame causes the flicker at the decoded intra-frame. The flicker greatly degrades the overall perceptual quality of a video, thereby hampering the user experience.

The conventional technologies reduce the flicker by adjusting quantization step size of the intra-frames. However, there are so many factors associated with the flicker, due to which the adjustment of the quantization step size is very complex and difficult to implement. While the conventional technologies reduce the flicker to some degree, they do not eliminate it completely.

### SUMMARY

In accordance with the disclosure, there is provided a video data encoding method including inter-coding a block of an image frame to generate an inter-coded block, reconstructing the inter-coded block to generate a reconstructed block, and intra-coding the reconstructed block to generate a double-coded block.

Also in accordance with the disclosure, there is provided a video data encoding apparatus including a memory storing instructions and a processor coupled to the memory. The processor is configured to execute the instructions to inter-code a block of an image frame to generate an inter-coded block, reconstruct the inter-coded block to generate a reconstructed block, and intra-code the reconstructed block to generate a double-coded block.

### BRIEF DESCRIPTION OF THE DRAWINGS

FIG. 1 is a schematic diagram showing an encoding apparatus according to exemplary embodiments of the disclosure.

FIG. 2 is a schematic block diagram showing an encoder according to exemplary embodiments of the disclosure.

FIG. 3 schematically illustrates a segmentation of an image frame of video data according to exemplary embodiments of the disclosure.

FIG. 4 is flow chart of a method of encoding video data according to an exemplary embodiment of the disclosure.

FIG. 5 schematically shows a data flow diagram according to an exemplary embodiment of the disclosure.

FIG. 6 is a flow chart of a method of encoding video data according to another exemplary embodiment of the disclosure.

### DETAILED DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

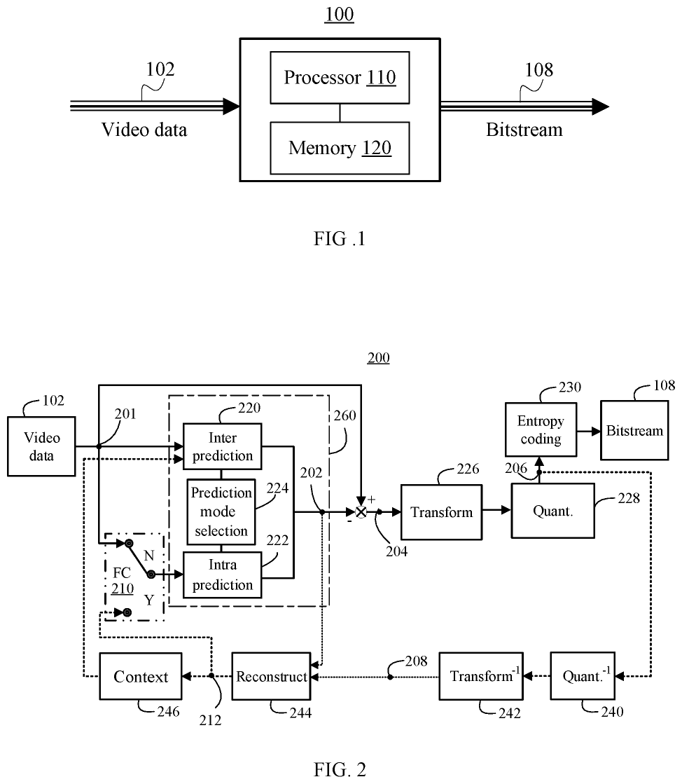

FIG. 1 is a schematic diagram showing an exemplary encoding apparatus 100 consistent with the disclosure. The encoding apparatus 100 is configured to receive video data 102 and encode the video data 102 to generate a bitstream 108, which can be transmitted over a transmission channel.

In some embodiments, the video data 102 may include a plurality of raw (e.g., unprocessed or uncompressed) image frames generated by any suitable image source, such as a video recorder, a digital camera, an infrared camera, or the like. For example, the video data 102 may include a plurality of uncompressed image frames acquired by a digital camera.

The encoding apparatus 100 may encode the video data 102 according to any suitable video encoding standard, such as Windows Media Video (WMV), Society of Motion Picture and Television Engineers (SMPTE) 421-M format, Moving Picture Experts Group (MPEG), e.g., MPEG-1, MPEG-2, or MPEG-4, H.26x format, e.g., H.261, H.262, H.263, or H.264, or another standard. In some embodiments, the video encoding format may be selected according to the video encoding standard supported by a decoder, transmission channel conditions, the image quality requirement, and the like. For example, the video data encoded using the MPEG standard needs to be decoded by a corresponding decoder adapted to support the appropriate MPEG standard. A lossless compression format may be used to achieve a high image quality requirement. A lossy compression format may be used to adapt to limited transmission channel bandwidth.

In some embodiments, the encoding apparatus 100 may implement one or more different codec algorithms. The selection of the codec algorithm may be based on the encoding complexity, encoding speed, encoding ratio, encoding efficiency, and the like. For example, a faster codec algorithm may be performed in real-time on low-end hardware. A high encoding ratio may be desirable for a transmission channel with a small bandwidth.

In some embodiments, the encoding of the video data 102 may further include at least one of encryption, error-correction encoding, format conversion, or the like. For example, when the video data 102 contains confidential information, the encryption may be performed before transmission or storage to protect confidentiality.

In some embodiments, the encoding apparatus 100 may perform intra-coding (also referred to as intra-frame coding, i.e., coding based on information in a same image frame), inter-coding (also referred to as inter-frame coding, i.e., coding based on information from different image frames), or both intra-coding and inter-coding on the video data 102 to generate the bitstream 108. For example, the encoding apparatus 100 may perform intra-coding on some frames and inter-coding on some other frames of the video data 102. A frame subject to intra-coding is also referred to as an intra-coded frame or simply intra-frame, and a frame subject to inter-coding is also referred to as an inter-coded frame or simply inter-frame. In some embodiments, a block, e.g., a macroblock (MB), of a frame can be intra-coded and thus be referred to as an intra-coded block or intra block. In the periodic intra-coding scheme, intra-frames can be periodically inserted in the bitstream 108 and image frames between the intra-frames can be inter-coded. Similarly, in the periodic intra-refresh scheme, intra macroblocks (MBs) can be periodically inserted in the bitstream 108 and the MBs between the intra MBs can be inter-coded.

In some embodiments, as shown in FIG. 1, the encoding apparatus 100 includes a processor 110 and a memory 120 coupled to the processor 110. The processor 110 may be any suitable hardware processor, such as an image processor, an image processing engine, an image-processing chip, a graphics-processor (GPU), a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The memory 120 may include a non-transitory computer-readable storage medium, such as a random access memory (RAM), a read only memory, a flash memory, a volatile memory, a hard disk storage, or an optical media. The memory 120 may store computer program instructions, the video data 102, the bitstream 108, and the like. The processor 110 is configured to execute the computer program instructions that are stored in the memory 120, to perform a method consistent with the disclosure, such as one of the exemplary methods described below.

In some embodiments, the bitstream 108 can be transmitted over a transmission channel. The transmission channel may use any form of communication connection, such as the Internet connection, cable television connection, telephone connection, wireless connection, or other connection capable of supporting the transmission of video data. For example, the transmission channel may be a wireless local area network (WLAN) channel. The transmission channel may use any type of physical transmission medium, such as cable (e.g., twisted-pair wire, cable, and fiber-optic cable), air, water, space, or any combination of the above media. For example, the encoding apparatus 100 may transmit the bitstream 108 over the air, when being carried by an unmanned aerial vehicle (UAV) or an airplane, or water, when being carried by a driverless boat or a submarine, or space, when being carried by a spacecraft or a satellite.

In some embodiments, the encoding apparatus 100 may be integrated in a mobile body, such as a UAV, a driverless car, a mobile robot, or the like. For example, when the encoding apparatus 100 is integrated in a UAV, the encoding apparatus 100 can receive the video data 102 acquired by an image sensor arranged on the UAV, such as a charge-coupled device (CCD) sensor, a complementary metal-oxide-semiconductor (CMOS) sensor, or the like. The encoding apparatus 100 can encode the video data 102 to generate the bitstream 108. The bitstream 108 may be transmitted by a transmitter in the UAV to a remote controller or a terminal device with an application (app) that can control the UAV, such as a smartphone, a tablet, a game device, or the like.

FIG. 2 is a schematic block diagram showing an exemplary encoder 200 consistent with the disclosure. As shown in FIG. 2, the video data 102 is received by the encoder 200. The video data 102 may be divided into processing units to be encoded (not shown). In some embodiments, the processing units to be encoded may be slices, MBs, sub-blocks, or the like.

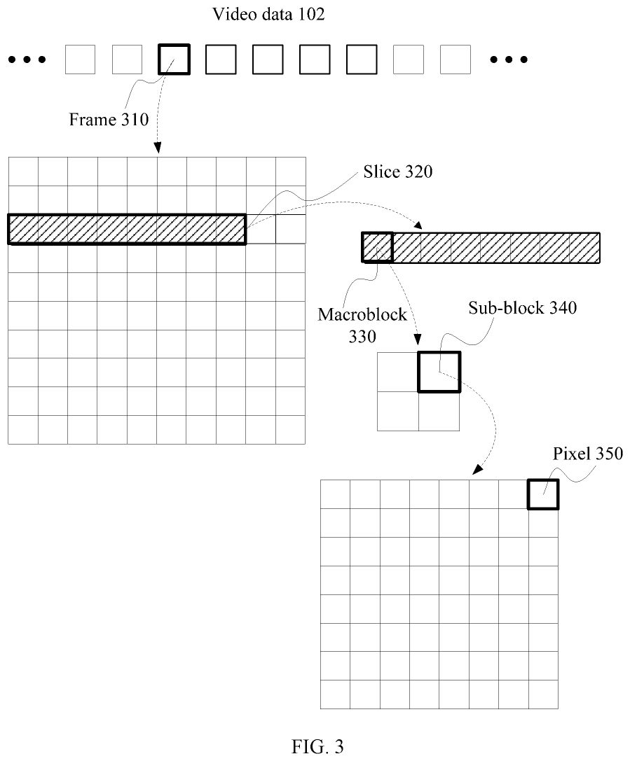

FIG. 3 schematically illustrates a segmentation of an image frame of the video data 102 consistent with the disclosure. As shown in FIG. 3, the video data 102 includes a plurality of image frames 310. For example, the plurality of image frames 310 may be a sequence of neighboring frames in a video stream. Each one of the plurality of image frames 310 may be partitioned into one or more slices 320. Each one of the one or more slices 320 may be partitioned into one or more MBs 330. For example, an image frame may be partitioned into fixed-sized MBs, which are the basic syntax and processing unit employed in H.264 standard. Each MB covers 16×16 pixels. In some embodiments, each one of the one or more MBs 330 can be further partitioned into one or more sub-blocks 340, which include one or more pixels 350. For example, when tracking a moving object, an MB may be further subdivided into sub-blocks for motion-compensation prediction. Each one of the one or more pixels 350 may include one or more data sets corresponding to one or more data elements, such as luminance and chrominance elements. For example, each MB employed in H.264 standard includes 16×16 data sets of luminance element and 8×8 data sets of each of the two chrominance elements.

In some embodiments, each one of the one or more slices 320 may include a sequence of the one or more MBs 330, which can be processed in a scan order, for example, left to right, beginning at the top. In some embodiments, the one or more MBs 330 may be grouped in any direction and/or order to create the one or more slices 320, i.e., the slices 320 may have arbitrary size, shape, and/or slice ordering. In the example shown in FIG. 3, the slice 320 is contiguous. However, a slice can also be non-contiguous. For example, when using flexible MB ordering (FMO), the image frame can be divided in different scan patterns of the MBs corresponding to different slice group types, such as interleaved slice groups, scattered or dispersed slice groups, foreground groups, changing groups, explicit groups, or the like, and hence the slice can be non-contiguous. An MB allocation map (MBAmap) may be used to define the scan patterns of the MBs. The MBAmap may include slice group identification numbers and information about which slice groups the MBs belong. In some embodiments, the one or more slices 320 used with FMO are not static and can be changed as circumstances change, such as tracking a moving object.

It will be appreciated that the manners of image segmentation described above are merely examples for illustrative purposes and are not intended to limit the scope of the disclosure. In some embodiments, the segmentation may be only applied to a region-of-interest (ROI) of an arbitrary shape within the image frame. For example, an ROI may be a face region in an image frame.

The image frames of the video data 102 may be intra-coded or inter-coded. The intra-coding employs spatial prediction, which exploits spatial redundancy contained within one frame. The inter-coding employs temporal prediction, which exploits temporal redundancy between neighboring frames. For example, the first image frame of the video data 102 or image frames at random access points of the video data 102 may be intra-coded, and the remaining frames, i.e., images frames other than the first image frame, of the video data 102 or the image frames between random access points may be inter-coded. An access point may refer to, e.g., a point in the stream of the video data 102 from which the video data 102 is started to be encoded or transmitted, or from which the video data 102 is resumed to be encoded or transmitted. In some embodiments, an inter-coded frame may contain intra-coded MBs. Taking the periodic intra-refresh scheme as an example, intra-coded MBs can be periodically inserted into a predominantly inter-coded frame. Taking an on-demand intra-refresh scheme as another example, intra-coded MBs can be inserted into a predominantly inter-coded frame when needed, such as, when a transmission error, a sudden change of channel conditions, or the like, occurs. In the exemplary encoder 200, one or more image frames can also be double-coded, i.e., first inter-coded and then intra-coded, to reduce the flicker based on a method consistent with the disclosure, such as one of the exemplary methods described below.

Taking the video data 102 processed in units of MBs as an example, the encoding process as shown in FIG. 2 can be performed on the MBs. As shown in FIG. 2, the encoder 200 includes a “forward path” connected by solid-line arrows and an “inverse path” connected by dashed-line arrows in the figure. The “forward path” includes conducting the encoding of a current MB 201 and the “inverse path” includes implementing a reconstruction process, which generates context (e.g., the context 246 as shown in FIG. 2) for prediction of a next MB.

In some embodiments, as shown in FIG. 2, the “forward path” includes a prediction process 260, a transformation process 226, and a quantization process 228. The prediction process 260 includes an inter-prediction having one or more inter-prediction modes 220, an intra-prediction having one or more intra-prediction modes 222, and a prediction mode selection process 224. Taking H.264 for an example, H.264 supports nine intra-prediction modes for luminance 4×4 and 8×8 blocks, including 8 directional modes and an intra direct component (DC) mode that is a non-directional mode. For luminance 16×16 blocks, H.264 supports 4 intra-prediction modes, i.e., Vertical mode, Horizontal mode, DC mode, and Plane mode. Further, H.264 supports all possible combination of inter-prediction modes, such as variable block sizes (i.e., 16×16, 16×8, 8×16, 8×8, 8×4, 4×8, 4×4) used in inter-frame motion estimation, different inter-frame motion estimation modes (i.e., use of integer, half, or quarter pixel motion estimation), multiple reference frames.

The current MB 201 can be sent to the prediction process 260 for being predicted according to one of the one or more inter-prediction modes 220 when inter-coding is employed or one of the one or more intra-prediction modes 222 when intra-coding is employed to form a predicted MB 202. In the one or more intra-prediction modes 222, the predicted MB 202 is created using a previously encoded MB from the current frame. In the one or more inter-prediction modes 220, the previously encoded MB from a past or a future frame (a neighboring frame) is stored in the context 246 and used as a reference for inter-prediction. In some embodiments, two or more previously encoded MBs from one or more past frames and/or one or more future frames may be stored in the context 246, to provide more than one reference for inter-coding an MB.

In some embodiments, the prediction mode selection process 224 includes determining whether to apply the intra-coding or the inter-coding on the current MB. In some embodiments, which one of the intra-coding or inter-coding to be applied on the current MB can be determined according to the position of the current MB. For example, if the current MB is in the first image frame of the video data 102 or in an image frame at one of random access points of the video data 102, the current MB may be intra-coded. On the other hand, if the current MB is in one of the remaining frames of the video data 102 or in an image frame between two random access points, the current MB may be inter-coded. In some other embodiments, which one of the intra-coding or inter-coding to be employed can be determined according to a preset interval that determines how frequently the intra-coded MBs can be inserted. That is, if the current MB is at the preset interval from last intra-coded MB, the current MB can be intra-coded, otherwise, the current MB can be inter-coded. In some other embodiments, which one of the intra-coding or inter-coding to be employed on the current MB can be determined according to a transmission error, a sudden change of channel conditions, or the like. That is, if a transmission error occurs or a sudden change of channel conditions occurs when the current MB is generated, the current MB can be intra-coded.

In some embodiments, the prediction mode selection process 224 further selects an intra-prediction mode for the current MB from the one or more intra-prediction modes 222 when intra-coding is employed and an inter-prediction mode from the one or more inter-prediction modes 220 when inter-coding is employed. Any suitable prediction mode selection technique may be used here. For example, H.264 uses a Rate-Distortion Optimization (RDO) technique to select the intra-prediction mode or the inter-prediction mode that has a least rate-distortion (RD) cost for the current MB.

As shown in FIG. 2, the predicted MB 202 is subtracted from the current MB 201 to generate a residual MB 204. The residual MB 204 is then transformed 226 from the spatial domain into a representation in the frequency domain (also referred to as spectrum domain), in which the residual MB 204 can be expressed in terms of a plurality of frequency-domain components, such as a plurality of sine and/or cosine components. Coefficients associated with the frequency-domain components in the frequency-domain expression are also referred to as transform coefficients. Due to the two-dimensional (2D) nature of the image frames (and blocks, MBs, etc., of the image frames), the transform coefficients can usually be arranged in a 2D form as a coefficient array. Any suitable transformation method, such as a discrete cosine transform (DCT), a wavelet transform, or the like, can be used here.

Further, the transform coefficients are quantized 228 to provide quantized transform coefficients 206. For example, the quantized transform coefficients 206 may be obtained by dividing the transform coefficients with a quantization step size (Qₛₜₑₚ).

As shown in FIG. 2, the quantized transform coefficients 206 are then entropy encoded 230. In some embodiments, the quantized transform coefficients 206 may be reordered (not shown) before entropy encoding 230.

The entropy encoding 230 can convert symbols into binary codes and thus an obtained encoded block in the form of bitstream can be easily stored and transmitted. For example, context-adaptive variable-length coding (CAVLC) is used in H.264 standard to generate bitstreams. The symbols which are to be entropy encoded include, but are not limited to, the quantized transform coefficients 206, information for enabling the decoder to recreate the prediction (e.g., selected prediction mode, partition size, and the like), information about the structure of the bitstream, information about a complete sequence (e.g., MB headers), and the like.

In some embodiments, as shown in FIG. 2, the “inverse path” includes an inverse quantization process 240, an inverse transformation process 242, and a reconstruction process 244. The quantized transform coefficients 206 are inversely quantized 240 and inversely transformed 242 to generate a decoded residual MB 208. The inverse quantization 240 is also referred to as a re-scaling process, where the quantized transform coefficients 206 are multiplied by the quantization step size (Qₛₜₑₚ) to obtain rescaled coefficients, respectively. The rescaled coefficients may be similar to but not exactly the same as the original transform coefficients. The rescaled coefficients are inversely transformed to generate the decoded residual MB 208. An inverse transformation method corresponding to the transformation method used in the transformation process 226 can be used here. For example, if the DCT is used in the transformation process 226, a reverse DCT can be used in the reverse transformation process 242. As another example, if the wavelet transform is used in the transformation process 226, a reverse wavelet transform can be used in the reverse transformation process 242.

Due to the losses that occur in the quantization process 228, the decoded residual MB 208 may be different from the original residual MB 204. The difference between the original and decoded residual blocks may be positively correlated to the quantization step size. That is, the use of a coarse quantization step size introduces a large bias into the decoded residual MB 208 and the use of a fine quantization step size introduces a small bias into the decoded residual MB 208. The decoded residual MB 208 is added to the predicted MB 202 to create a reconstructed MB 212, which is stored in the context 246 as a reference for prediction of the next MBs.

In some embodiments, the encoder 200 may be a codec. That is, the encoder 100 may also include a decoder (not shown). The decoder conceptually works in a reverse manner including an entropy decoder (not shown) and the processing elements defined within the reconstruction process, shown by the “inverse path” in FIG. 2. The detailed description thereof is omitted here.

In some embodiments, the encoder 200 also includes a flicker-control 210. As shown in FIG. 2, the flicker-control 210 determines whether to feed an image frame of the video data 102 or a reconstructed image frame of the video data 102 to the intra-prediction 222. In some embodiments, the reconstructed image frame may be created by reconstructing an inter-coded image frame. When being directly fed into the intra-prediction 222 (denoted as letter N in FIG. 2), the image frame of the video data 102 is intra-coded. When being fed into the intra-prediction 222 after inter-coded and reconstructed (denoted as letter Y in FIG. 2), the image frame of the video data 102 is double-coded, i.e., coded twice, consistent with a method of the disclosure, such as one of the exemplary methods described below, to reduce the flicker. For example, in a double-coding process, an MB of the image frame can be first inter-predicted 220, transformed 226, and quantized 228 to generate the quantized transform coefficients 206. The quantized transform coefficients 206 can then be inversely quantized 240, inversely transformed 242, and reconstructed 244 to generate a reconstructed MB 212. The reconstructed MB 212 can then be intra-predicted 222, transformed 226, quantized 228, and entropy encoded 230 to generate a double-coded MB. In a decoder-side, a decoded MB can be generated by intra-decoding the double-coded MB, so that the decoded MB is similar to the reconstructed MB 212 that is derived from the inter-coded MB. As such, the decoded block resembles the preceding inter-coded block. Therefore, the double-coding can reduce, even eliminate, the flicker caused by large differences in coding noise patterns between inter-coding and intra-coding.

It is intended that modules and functions described in the exemplary encoder be considered as exemplary only and not to limit the scope of the disclosure. It will be appreciated by those skilled in the art that the modules and functions described in the exemplary encoder may be combined, subdivided, and/or varied.

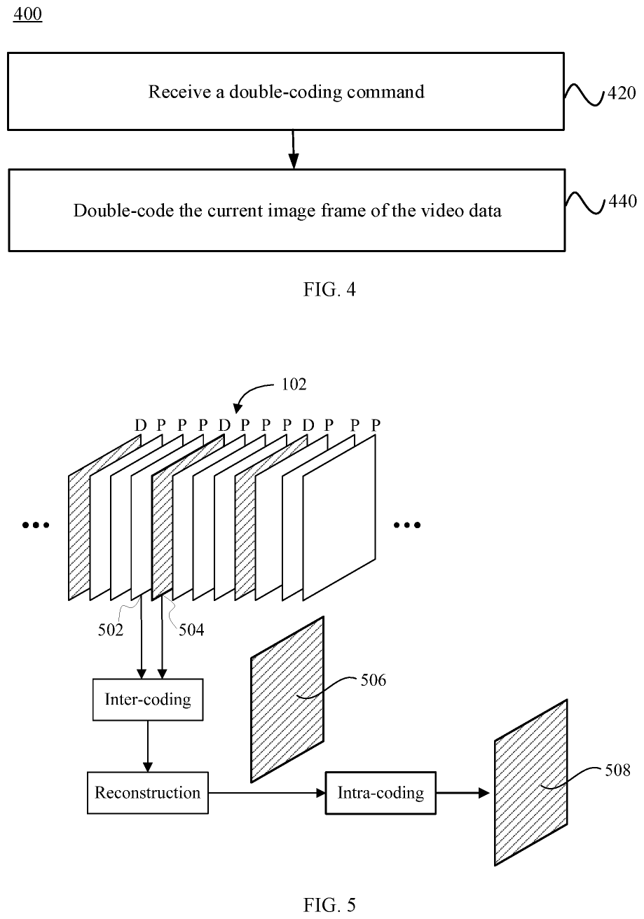

FIG. 4 is a flow chart of an exemplary method 400 of encoding video data consistent with the disclosure. The method 400 is adapted to reduce flicker caused by a distortion between a decoded intra-frame and a previously decoded inter-frame. The method 400 may be applied to intra-coded frames and/or intra-coded MBs.

In some embodiments, as shown in FIG. 4, at 420, a double-coding command is received. At 440, the current image frame of the video data is double-coded in response to the double-coding command, based on a method consistent with the disclosure, such as one of the exemplary methods described below.

In some embodiments, the double-coding command may be cyclically generated at a preset interval. The preset interval may also be referred to as a double-coding frame period and is inversely proportional to a double-coding frame insertion frequency, which indicates how frequently the image frames are double-coded. The preset interval may be determined according to at least one of a requirement of error recovery time, a historical transmission error rate, or attitude information from a mobile body. For example, a shorter preset interval can allow for a faster error recovery, i.e., a shorter error recovery time. As another example, when the historical transmission error rate is high, the double-coding frame may need to be inserted more frequently to avoid inter-frame error propagation. That is, a shorter preset interval may be used for a higher historical transmission error rate. As a further example, the attitude information from a mobile body may include orientation information of a camera carried by the mobile terminal, which determines the orientation of the obtained image, such as landscape, portrait, or the like. The preset interval may be inversely proportional to an attitude adjustment frequency (also referred to as an orientation adjustment frequency, which determines how frequently the attitude/orientation is adjusted), such that the double-coding can be adapted to the change of the attitude.

In some embodiments, the double-coding command may be generated at an adaptive interval. The interval may be dependent on a current transmission channel condition, current attitude information of the mobile body, and/or the like. For example, when the current transmission channel condition becomes worse, the interval may be decreased, i.e., the double-coding frame insertion frequency may be increased, to insert the double-coding frame more frequently.

In some embodiments, the double-coding command may be generated when a transmission error occurs. For example, when detecting a transmission error, the decoder-side sends a double-coding command to the encoder-side to request to insert a double-coding frame.

FIG. 5 schematically shows an exemplary data flow diagram consistent with the disclosure. As shown in FIG. 5, inter-coded frames are denoted by letter “P” and the double-coded frames are denoted by letter “D”. A frame to be double-coded 504 is first inter-coded with reference to a previously inter-coded frame 502 to generate an inter-coded frame. The reconstruction process, e.g., the reconstruction process 244 in FIG. 2, is then conducted on the inter-coded frame to output a reconstructed frame 506. Intra-coding is performed on the reconstructed frame 506 to generate a double-coded frame 508. As such, the reconstructed frame of the double-coded frame 508 and the reconstructed frame of the inter-frame 502 can resemble each other in the decoder-side. Therefore, the flicker at the intra-frames caused by large differences in coding noise patterns between inter-coding and intra-coding can be reduced, even eliminated.

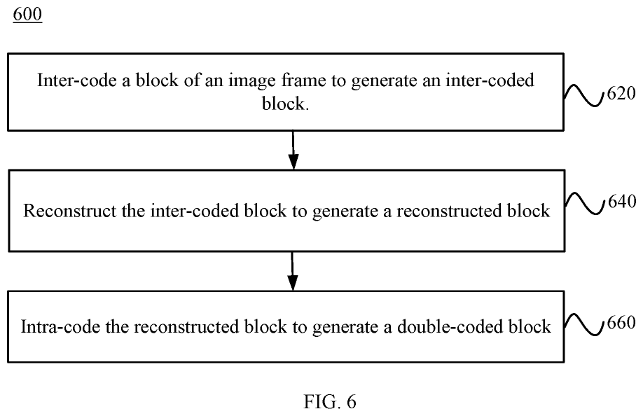

FIG. 6 is a flow chart of an exemplary method 600 of encoding video data consistent with the disclosure. The method 600 may be applied to intra-coded frames and/or intra-coded MBs. According to the method 600, an image frame can be double-coded by the encoding apparatus 100 or the encoder 200 to reduce the flicker. More specifically, the image frame is first inter-coded and then intra-coded, which makes the decoded double-coding frame to resemble the preceding decoded inter-frame. As such, the flicker due to the fact that the decoded intra-frame does not resemble the preceding decoded inter-frame can be reduced, even eliminated. Exemplary processes are described below in detail.

As shown in FIG. 6, at 620, a block of an image frame is inter-coded to generate an inter-coded block. In some embodiments, the entire image frame can be inter-coded to generate an inter-coded frame and the inter-coded block can be a block of the inter-coded frame that corresponds to the block of the image frame.

The block of the image frame may be the whole image frame or a portion of the image frame, which includes a plurality of pixels of the image frame. In some embodiments, the block of the image frame may be an MB, a sub-block, or the like. The size and type of the block of the image frame may be determined according to the encoding standard that is employed. For example, a fixed-sized MB covering 16×16 pixels is the basic syntax and processing unit employed in H.264 standard. H.264 also allows the subdivision of an MB into smaller sub-blocks, down to a size of 4×4 pixels, for motion-compensation prediction. An MB may be split into sub-blocks in one of four manners: 16×16, 16×8, 8×16, or 8×8. The 8×8 sub-block may be further split in one of four manners: 8×8, 8×4, 4×8, or 4×4. Therefore, when H.264 standard is used, the size of the block of the image frame can range from 16×16 to 4×4 with many options between the two as described above.

Inter-coding the block of the image frame may be accomplished according to any suitable video encoding standard, such as WMV, SMPTE 421-M, MPEG-x (e.g., MPEG-1, MPEG-2, or MPEG-4), H.26x (e.g., H.261, H.262, H.263, or H.264), or another standard. Inter-coding the block of the image frame may include applying inter-prediction, transformation, quantization, and entropy encoding to the block of the image frame. In an inter-prediction process, an inter-predicted block is generated using one or more previously coded blocks from one or more past frames and/or one or more future frames based on one of a plurality of inter-prediction modes. In some embodiments, the one of a plurality of inter-prediction modes can be a best inter-predication mode for the block of the image frame selected from the plurality of inter-predication modes that are supported by the video encoding standard that is employed.

Taking H.264 as an example, the inter-prediction can use one of a plurality of block sizes, i.e., 16×16, 16×8, 8×16, 8×8, 8×4, 4×8, 4×4. The inter-prediction in H.264 also includes a block matching process, during which a best matching block is identified as a reference block for the purposes of motion estimation. The best matching block refers to a block in a previously encoded frame (also referred to as a reference frame) that is similar to the block of the image frame. That is, there is a smallest prediction error between the best matching block and the block of the image frame. Any suitable block matching algorithm can be employed, such as exhaustive search, optimized hierarchical block matching (OHBM), three step search, two dimensional logarithmic search (TDLS), simple and efficient search, four step search, diamond search (DS), adaptive rood pattern search (ARPS), or the like.

Furthermore, H.264 also supports multiple reference frames, e.g., up to 32 reference frames including 16 past frames and 16 future frames. The prediction block can be created by a weighted sum of blocks from the reference frames. In this situation, the best inter-predication mode for the block of the image frame can be selected from all possible combinations of the inter-prediction modes supported by H.264 as described above. Any suitable inter-prediction mode selection technique can be used here. For example, an RDO technique selects the best inter-prediction mode which has a least RD cost.

The inter-predicted block is subtracted from the block of the image frame to generate a residual block.

In a transformation process, the residual block is transformed to the frequency domain for more efficient quantization and data compression. Any suitable transform algorithm can be used to obtain transform coefficients, such as discrete cosine transform (DCT), wavelet transform, time-frequency analysis, Fourier transform, lapped transform, or the like. Taking H.264 as an example, the residual block is transformed using a 4×4 or 8×8 integer transform derived from the DCT.

The quantization process is a lossy process, during which the transform coefficients are divided by a quantization step size (Qₛₜₑₚ) to obtain quantized transform coefficients. A larger value of the quantization step size results in a higher compression at the expense of a poorer image quality. In some embodiments, a quantization parameter (QP) is used to determine the quantization step-size. The relation between QP and Qₛₜₑₚ may be linear or exponential according to different encoding standards. Taking H.263 as an example, the relationship between QP and Qₛₜₑₚ is that Qₛₜₑₚ=2×QP. Taking H.264 as another example, the relationship between QP and Qₛₜₑₚ is that Qₛₜₑₚ=2^{QP/6}. H.264 allows a total of 52 possible values in QP, which are 0, 1, 2, . . . , 51, and each unit increase of QP lengthens the quantization step size by 12%.

In the entropy encoding process, the quantized transform coefficients are converted into binary codes and thus an inter-coded block in the form of bitstream is obtained. Any suitable entropy encoding technique may be used, such as Huffman coding, Unary coding, Arithmetic coding, Shannon-Fano coding, Elias gamma coding, Tunstall coding, Golomb coding, Ricde coding, Shannon coding, Range encoding, universal coding, exponential-Golomb coding, Fibonacci coding, or the like. In some embodiments, the quantized transform coefficients may be reordered before being subject to the entropy encoding.

At 640, the inter-coded block is reconstructed to generate a reconstructed block. Reconstructing the inter-coded block may include applying entropy decoding, inverse quantization and inverse transformation, and reconstruction to the inter-coded block. In some embodiments, the entire inter-coded frame can be reconstructed to generate a reconstructed frame, and the reconstructed block can be a block of the reconstructed frame corresponding to the inter-coded block.

The entropy decoding process converts the inter-coded block in the form of bitstream into reconstructed quantized transform coefficients. An entropy decoding technique corresponds to the entropy encoding technique, which is employed for inter-coding the block of the image frame at 620, can be used. For example, when Huffman coding is employed in the entropy encoding process, Huffman decoding can be used in the entropy decoding process. As another example, when Arithmetic coding is employed in the entropy encoding process, Arithmetic decoding can be used in the entropy decoding process.

In some embodiments, the entropy decoding process can be omitted, and reconstructing the inter-coded block can be accomplished by directly applying the inverse quantization and the inverse transformation on the quantized transform coefficients that is obtained during inter-coding the block of the image frame at 620. In some embodiments, the inverse quantization and the inverse transformation may be referred to as re-scaling and inverse transform processes, respectively.

In the inverse quantization process, the reconstructed quantized transform coefficients (or the quantized transform coefficients in the embodiments in which the entropy decoding process is omitted) are multiplied by the Qₛₜₑₚ to generate reconstructed transform coefficients, which may be referred to as rescaled coefficients. In some embodiments, during the inverse quantization process, the reconstruction of the transform coefficients requires at least two multiplications involving rational numbers. For example, in H.264, a reconstructed quantized transform coefficient (or a quantized transform coefficient) is multiplied by three numbers, e.g., the Qₛₜₑₚ, a corresponding Pre-scaling Factor (PF) for the inverse transform, and a constant value 64. The value of the PF corresponding to a reconstructed quantized transform coefficient (or a quantized transform coefficient) may depend on a position of the reconstructed quantized transform coefficient (or the quantized transform coefficient) in the corresponding coefficient array. In some embodiments, the rescaled coefficients are similar but may not be exactly the same as the transform coefficients.

The inverse transform process can create a reconstructed residual block. An inverse transform algorithm corresponds to the transform algorithm, which is employed for inter-coding the block of the image frame, may be selected to be used. For example, in H.264, the 4×4 or 8×8 integer transform derived from the DCT is employed in the transform process, and hence the 4×4 or 8×8 inverse integer transform can be used in the inverse transform process.

In the reconstruction process, the reconstructed residual block is added to the inter-predicted block to create the reconstructed block.

At 660, the reconstructed block is intra-coded to generate a double-coded block. In some embodiments, the entire reconstructed frame can be intra-coded to generate a double-coded frame, and the double-coded block can be a block of the double-coded frame that corresponds to the reconstructed block.

Intra-coding the reconstructed block may be accomplished according to any suitable video encoding standard, such as WMV, SMPTE 421-M, MPEG-x (e.g., MPEG-1, MPEG-2, or MPEG-4), H.26x (e.g., H.261, H.262, H.263, or H.264), or another format. In some embodiments, intra-coding the reconstructed block may use the same video encoding standard as that used in inter-coding the block of the image frame at 620.

Intra-coding the reconstructed block may include applying intra-prediction, transformation, quantization, and entropy encoding to the reconstructed block. In the intra-prediction process, an intra-predicted block is generated using the reconstructed block based on one of a plurality of intra-prediction modes. In some embodiments, the one of a plurality of intra-prediction modes can be a best intra-predication mode for the block of the image frame selected from the plurality of intra-predication modes that are supported by the video encoding standard that is employed.

Taking H.264 for an example, H.264 supports nine intra-prediction modes for luminance 4×4 and 8×8 blocks, including 8 directional modes and an intra DC mode that is a non-directional mode. In this situation, the best intra-predication mode for the block of the image frame can be selected from all intra-prediction modes supported by H.264 as described above. Any suitable intra-prediction mode selection technique can be used here. For example, an RDO technique selects the best intra-prediction mode which has a least RD cost.

The intra-predicted block is subtracted from the reconstructed block to generate a residual block.

The residual block is transformed to obtain transform coefficients, which is then quantized to generate quantized transform coefficients. The double-coded block is then generated by converting the quantized transform coefficients into binary codes based on an entropy encoding process. The double-coded block in the form of bitstream may be transmitted over a transmission channel. In some embodiments, the quantized transform coefficients may be reordered before being subject to entropy encoding. The transform process and entropy encoding process for intra-coding the reconstructed block are similar to those for inter-coding the block of the image frame described above, and thus detailed description thereof is omitted here.

In some embodiments, intra-coding the reconstructed block includes intra-coding the reconstructed block using a fine quantization step size. The quantization process can cause data loss due to rounding or shifting operations by dividing the transform coefficients by a quantization step size. Decreasing the quantization step size can decrease the distortion occurred in the quantization process. Therefore, using a fine quantization step size can decrease the distortion between the reconstructed block from an inter-coded block at 640 and a reconstructed block from a double-coded block at 660, so as to reduce the flicker.

In some embodiments, the fine quantization step size may correspond to a QP within the range of 12˜20. In some embodiments, the fine quantization step size may be equal to or smaller than the quantization step size used for inter-coding the block of the image frame at 620. For example, the quantization parameter corresponding to the fine quantization step size can be smaller than a quantization parameter corresponding to the quantization step size used for inter-coding the block of the image frame at 620 by a value in a range of 0˜7.

In some embodiments, intra-coding the reconstructed block includes applying a lossless intra-coding to the reconstructed block. In the lossless intra-coding process, the quantization and transformation processes can be skipped since those two processes can cause data loss. Thus, the residual block obtained by intra-prediction is directly encoded by entropy encoding. Any suitable lossless intra-coding algorithm may be used here. The selection of the lossless intra-coding algorithm may be determined by the encoding standard that is employed.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method of encoding video data, comprising:
inter-coding a block of an image frame to generate an inter-coded block;
reconstructing the inter-coded block to generate a reconstructed block; and
intra-coding the reconstructed block to generate a double-coded block.

2. The method of encoding video data according to claim 1, wherein intra-coding the reconstructed block includes intra-coding the reconstructed block using a fine quantization step size.

3. The method of encoding video data according to claim 2, wherein intra-coding the reconstructed block using the fine quantization step size includes intra-coding the reconstructed block using a quantization step size corresponding to a quantization parameter (QP) within the range of 12˜20.

4. The method of encoding video data according to claim 2, wherein intra-coding the reconstructed block using the fine quantization step size includes intra-coding the reconstructed block using a first quantization step size equal to or smaller than a second quantization step size used for inter-coding the block of the image frame, a first quantization parameter corresponding to the first quantization step size being equal to a second quantization parameter corresponding to the second quantization step size or being smaller than the second quantization parameter by a value in a range of 0˜7.

5. An apparatus for encoding video data, comprising:
a processor; and
a memory coupled to the processor and storing instructions that, when executed by the processor, cause the processor to:
inter-code a block of an image frame to generate an inter-coded block;
reconstruct the inter-coded block to generate a reconstructed block; and
intra-code the reconstructed block to generate a double-coded block.

6. The apparatus for encoding video data according to claim 5, wherein the instructions further cause the processor to:
intra-code the reconstructed block using a fine quantization step size.

7. The apparatus for encoding video data according to claim 6, wherein the instructions further cause the processor to:
intra-code the reconstructed block using a quantization step size corresponding to a QP within the range of 12˜20.

8. The apparatus for encoding video data according to claim 6, wherein the instructions further cause the processor to:
intra-code the reconstructed block using a first quantization step size equal to or smaller than a second quantization step size used for inter-coding the block of the image frame, a first quantization parameter corresponding to the first quantization step size being equal to a second quantization parameter corresponding to the second quantization step size or being smaller than the second quantization parameter by a value in a range of 0˜7.

9. The apparatus for encoding video data according to claim 5, wherein the instructions further cause the processor to:
apply a lossless intra-coding to the reconstructed block; or
apply intra-prediction, transformation, quantization, and entropy encoding to the reconstructed block.

10. The apparatus for encoding video data according to claim 9, wherein the instructions further cause the processor to:
subtract an intra-predicted block from the reconstructed block to generate a residual block.

11. The apparatus for encoding video data according to claim 10, wherein the instructions further cause the processor to:
transform the residual block into transform coefficients;
quantize the transform coefficients to generate quantized transform coefficients; and
entropy encode the quantized transform coefficients to generate the double-coded block.

12. The apparatus for encoding video data according to claim 5, wherein the instructions further cause the processor to:
apply inter-prediction, transformation, quantization, and entropy encoding to the block of the image frame.

13. The apparatus for encoding video data according to claim 12, wherein the instructions further cause the processor to:
search for a best matching block as an inter-predicted block; and
subtract the inter-predicted block from the block of the image frame to generate a residual block.

14. The apparatus for encoding video data according to claim 13, wherein the instructions further cause the processor to:
transform the residual block into transform coefficients;
quantize the transform coefficients to generate quantized transform coefficients;
entropy encode the quantized transform coefficients to generate the inter-coded block.

15. The apparatus for encoding video data according to claim 5, wherein the instructions further cause the processor to:
apply entropy decoding, inverse transform and re-scaling processes, and reconstruction to the inter-coded block.

16. The apparatus for encoding video data according to claim 15, wherein the instructions further cause the processor to:
entropy decode the inter-coded block to obtain quantized transform coefficients;
inversely transform and inversely quantize the quantized transform coefficients to obtain a residual block;
generate the reconstructed block according to the residual block and an inter-predicted block.

17. The apparatus for encoding video data according to claim 5, wherein the instructions further cause the processor to, before intra-coding the reconstructed block:
receive a double-coding command, and
intra-code the reconstructed block in response to the double-coding command being valid.

18. The apparatus for encoding video data according to claim 17, wherein the instructions further cause the processor to:
generate the double-coding command at a preset interval or an adaptive interval.

19. The apparatus for encoding video data according to claim 18, wherein the instructions further cause the processor to:
determine the preset interval or the adaptive interval according to at least one of:
a requirement of error recovery time,
a historical transmission error rate, or
attitude information from a mobile body.

20. The apparatus for encoding video data according to claim 18, wherein the instructions further cause the processor to:
receive the double-coding command in response to an occurrence of a transmission error.
